(19) United States
(12) Patent Application Publication
(10) Pub. No.: US 2022/0130006 A1
(43) Pub. Date: Apr. 28, 2022

(54) TRADEMARK EVALUATION DEVICE

(71) Applicant: Ichiro KUDO, Tokyo (JP)

(72) Inventors: Ichiro Kudo, Tokyo (JP); Tsuyoshi Yagino, Tokyo (JP)

(21) Appl. No.: 16/873,776

(22) PCT Filed: Dec. 10, 2018
(86) PCT No.: PCT/JP2018/045304

§ 371 Date: Jul. 6, 2020

(30) Foreign Application Priority Data
Dec. 8, 2017 (JP) 2017-236459

(51) Int. Cl. G06Q 50/18; G06Q 30/02

(52) U.S. Cl. CPC G06Q 50/184; G06Q 30/0206

(57) ABSTRACT

An object is to propose a device for calculating the value of a trademark (trademark power) according to an evaluation method capable of specifying a causal relationship with economic activity: various functions of a trademark right. In order to solve the above problem, the trademark evaluation device of the present invention, in the trademark population owned by a same trademark right holder, identifies a trademark including a mark that has a similar relationship to the mark that constitutes the trademark, and measures the similarity number N of each trademark. Next, the basic value A, which is a base value for evaluating the value of one trademark, is measured from the cost spent for registering the trademark, and the like. Finally, the value of the trademark (trademark power) is calculated as the basic value A raised to the power of “N raised to the (K/M)” (M, K≥1).

### TECHNICAL FIELD

The present invention relates to a trademark evaluation device for calculating trademark powers: a relative power which a trademark obtains, a relative value of a trademark, a relative additional value which a trademark adds to goods, and a relative attractiveness to a customer of a trademark, and the like by using registered trademark data, and an operation method thereof.

### BACKGROUND ART

Conventionally, as a typical trademark evaluation method, a monetary evaluation method of calculating a value per trademark right has been used.

In the conventional financial evaluation method, various methods such as the DCF method using scoring, the Black-Scholes model, the cost approach, and the market approach, a brand evaluation model of United States Department of Commerce, have been used. Since these methods are financial and economic evaluations, they are in high demand in the case of transfer of a patent right and in the case of entry into the balance sheet of the value of a trademark right (at the time of M&A), however, there are problems that the subjectivity is easy to enter in the qualitative analysis (scoring), and it takes enormous cost to evaluate all trademark rights, and the like.

On the other hand, some of relative evaluation methods include statistical evaluation methods that analyze the number of trademarks owned, the number of trademark applications, applying goods and services, and the like. Since these methods are data-oriented, they are easy to secure objectivity and exhibit its function in situations such as comparing the relative the number of trademarks owned, the number of trademark applications, applying goods and services, and the like with a competitor, however, there were problems such as difficulty identifying the causal relationship between the result and economic activities (exclusive power possessed by a patent right).

In calculating the value of a trademark, a method that considers market information, such as market data, financial data, or marketing data, on the goods in which the trademark is used, the amount of publicity advertising of the goods, and the degree of exposure to society is also conceived. However, it requires a lot of effort, is complicated, and is apt to be arbitrary.

### PATENT LITERATURE

### Patent literature 1: JP 2005-352982

### SUMMARY OF INVENTION

### Technical Problems

In other words, in the technology as described in Patent literature 1, a great deal of labor is required, such as inputting a score for an evaluation element for goods or services related to a trademark or conducting a questionnaire survey of an image accepted from the goods or services related to the trademark, and so exhaustive valuation was difficult. Also, as described above, it was difficult to specify the causal relationship between the result and the economic activity (the various economic functions of the trademark) by the relative evaluation method. Therefore, it was difficult to evaluate the value of a trademark right or a group of trademark rights, and no appropriate method has been developed so far. However, in recent years, intellectual property is said to occupy a large part of corporate value, there is a need for standard indicators to confirm the results of intellectual management. It is therefore an object of the present invention to propose a device for calculating trademark power in accordance with an evaluation method capable of specifying a causal relationship with economic activities (various functions of the trademark right).

### Solutions to Problems

The present invention proposes the following trademark evaluation device and an operation method of the trademark evaluation device. The following term “trademark” is based on the one after registration, but may include the pending application.

Specifically, the first invention is the trademark evaluation device comprising a population trademark ID acquisition unit that acquires a population trademark ID that is trademark IDs of a plurality of trademarks (pending trademarks and/or registered trademarks) serving as a population; a similar relation holding unit that holds trademark IDs associated with each other, which identify a trademark composed of a similar mark, wherein the trademarks identified by the population trademark ID owned by a same trademark right holder; a similarity number acquisition unit that acquires the number N, that is the number of trademark IDs held in association with the trademark ID in the similar relation holding unit; a basic value acquisition unit that acquires a basic value A (A>0), which is a basic value for evaluating the value of one trademark, in association with the trademark ID; a trademark value calculation unit that calculates the trademark value identified by the trademark ID using the value that is calculated by the basic value A raised to the power of “N raised to the (K/M)” (M, K≥1).

The second invention is the trademark evaluation device based on the first invention, further comprising a tallying unit that adds up the value of all trademarks and/or trademark groups owned by a trademark right holder in the population for each trademark right holder, wherein if the trademark which the value calculated has another trademark with a similar relationship, the value A raised to the power of “N raised to the (K/M)” (M, K≥1) is the value of the trademark group including another trademark, and if there is no other trademark with a similar relationship, the value A raised to the power of “N raised to the (K/M)” (M, K≥1) is the value of the trademark alone.

The third invention is the trademark evaluation device based on the second invention, further comprising an output unit concerning each trademark right holder, which outputs the total value calculated by the tallying unit in association with a trademark right holder.

The fourth invention is the trademark evaluation device based on any one of first to third invention, which the population trademark ID acquisition unit comprising the first designated population acquisition unit, wherein the first designated population acquisition unit acquires trademark IDs of a plurality of trademarks to be a population as trademark IDs of a population formed by using at least one of applying goods, applying services, a class of the goods, and a class of the services.

The fifth invention is the trademark evaluation device based on any one of first to fourth invention, which the population trademark ID acquisition unit comprising the second designated population acquisition unit, wherein the second designated population acquisition unit acquires trademark IDs of a plurality of trademarks to be a population as trademark IDs of a population formed by either a trademark including a company name or a trademark not including a company name.

The sixth invention is the trademark evaluation device based on any one of first to fifth invention, calculating by using the basic value A as at least one of, the number of years of the life of the registered trademark, the cost for obtaining to register the trademark, the cost for maintaining the registered trademark, the number of classes of goods and services, the number of the established licenses, the number of countries for international applications.

### Advantageous Effect of the Invention

According to the trademark evaluation device of the solutions, it is possible to evaluate the economic value of a trademark alone or a group of trademarks.

### DETAILED DESCRIPTIONS OF PREFERRED EMBODIMENTS

Hereinafter, the best mode for carrying out the present invention is described. The present invention is not limited to these embodiments at all, and can be implemented in various modes without departing from the gist thereof.

### Embodiment 1: Outline

The meaning of the total value finally calculated by the trademark evaluation device of the present embodiment is briefly described. The sum is calculated per trademark group consisting of one trademark or similar trademarks. The trademark evaluation device of the present embodiment is based on the idea that the value of the trademark is in the customer attracting power of the trademark and the like, and performs the calculation in accordance with a completely new method which has not been used in the past, which is mainly intended to directly measure the customer attracting power. Here, the customer attracting power is a power of to generate excess profits of the goods the trademark owner, and develops the soil as consumer trust, thereby adding value to the goods. Potentially, a trademark has functions of identifying its own and other goods, indicating its source, and assuring quality. These are economically valued in the form of the customer attracting power.

By the way, the customer attracting power is a power used to obtain excess profits, and specifically, it appears as an increase in sales or/and guaranteeing appropriate profits and elimination of cheap competition. And this power of trademark becomes larger as a consumer and a trader have more opportunities to contact with trademark. It is considered that the degree is increased by the degree of Nth power, where N is an opportunity for the consumer or the trader to encounter the trademark. In other words, if the chance of contact with the trademark is doubled, the customer attracting power is increased by the degree of the square, and if it is three times, it is the degree of the cube, and if it is four times, it is the degree of the fourth power. That is, the value obtained by adding some numerical operation to the Nth power indicates the degree to which the customer attracting power increases.

The extent to which the consumer and the trader actually have opportunities of contact with the trademark cannot be clearly determined without considerable market research. Therefore, it is extremely difficult to calculate the customer attracting power of the trademark, that is, the trademark value, by measuring the opportunity of contact with the trademark in the actual market. Even if it is possible, it is difficult to exhaustively calculate the trademark value for all registered trademarks. Therefore, the relationship that the opportunity of contact with the trademark increases in accordance with the number N of similar trademarks is used. If N or more similar trademarks (similar in a mark and similar in applying goods and services) belong to the same owner, compared to the case where a single trademark is owned, it can be assumed that the consumer and the trader have N times as many opportunities to contact with any similar trademarks. This is because, in principle, the trademark owned is used, and the chance of use and exposure to the consumer and the trader can generally be assumed to be the same for all trademarks. It should be noted that a similar trademark has the same ability to stimulate demand and attract customers to the customer and the trader.

The invention of the present application is a trademark evaluation device including a population trademark ID acquisition unit, a similar relation holding unit, a similarity number acquisition unit, a basic value acquisition unit, and a trademark value calculation unit.

The “population trademark ID acquisition unit” acquires a population trademark ID, which is a trademark ID of a plurality of trademarks (pending trademarks or/and registered trademarks) serving as a population. The trademark ID uniquely identifies each trademark in the present invention trademark evaluation device, and each trademark is associated with an attribute that can be browsed in the database of the USPTO. The attributes include an applicant, a trademark right holder, applying goods, applying services, a trademark registration filing date, a trademark registration date, and a pronunciation.

The “similar relation holding unit” holds trademark IDs associated with each other, which identify a trademark composed of a similar mark, wherein the trademarks identified by the population trademark ID owned by a same trademark right holder. As described above, each trademark is associated with a pronunciation as attributes. In some cases, only one pronunciation is associated with, but in some cases, a plurality of pronunciations is associated with. The similarity is judged by determining whether there is a match for the pronunciations of trademarks to be compared, and it is judged that trademarks having at least a part of the match have similarity. The trademark right holder who is the same or deemed as the same is not only completely the same, but also is the trademark right holder related to consolidated accounts based on their shareholding and the trademark right holder whose holding company and subordinate company can be considered the same.

The “similarity number acquisition unit” acquires the number N, that is the number of trademark IDs held in association with the trademark ID in the similar relation holding unit. The number N of trademark IDs is also the number of trademarks.

The “basic value acquisition unit” acquires a basic value A (A>0), which is a basic value for evaluating the value of one trademark, in association with the trademark ID. The basic value is the sum of the amount spent on registering and maintaining the trademark, but it is calculated by assuming the standard amount and using the same rules for all trademarks, instead of using the actual amount for each trademark right holder. Representative types of registration and maintenance costs are: a fee for USPTO at a time of filing, a patent attorney fee at a time of filing, a patent attorney fee for an office action, a fee for registration, a patent attorney contingency fee at a time of registration if it occurs, a patent attorney fee at a time of registration, a fee for registration at a time of renewal, a patent attorney fee at a time of renewal, a patent attorney fee for opposition, a patent attorney fee for invalidation trial, and the like.

It should be noted that the calculation is made assuming that a fee is charged regardless of whether a request is actually made to a patent attorney. There are two ways of thinking about the basic value when there is a similar trademark. One is to calculate a representative value of the amount of money to register and to maintain a plurality of trademarks and use this value for evaluating the value of a plurality of trademark groups having a similar relationship. The representative value includes an average value, a minimum value, a maximum value, the most recent registration and maintenance amount of the registered trademark, and the like. And even when there are multiple trademarks with a similar relationship, the registration and maintenance costs for each trademark are used as the basic value for each trademark, and finally, the evaluation value of a trademark having a similar relationship is added together to obtain the value of a group of similar trademarks. Regarding the procedure for calculating the basic value, data published by the USPTO is used. In the case of US, it is standardization data on a trademark. And it is also conceivable to use a constant for all trademarks as a basic value. Furthermore, it is also conceivable to adopt only the lifetime cost for USPTO of the trademark as the basic value.

The “trademark value calculation unit” calculates the trademark value identified by the trademark ID using the value that is calculated by the basic value A raised to the power of “N raised to the (K/M)” (M, K≥1). The reason why the Nth power is not directly employed is that the number of digits overflows when the calculation is performed by the computer. By appropriately selecting M and K, the overflow of the computer can be suppressed, and the dynamic range of the number of digits of the evaluation value can be suppressed to a predetermined width.

Concerning acquisition of procedure information from standardization data of USPTO, this function is realized by an raw standardization data of USPTO acquisition unit, an information extraction unit using to get a basic value from said standardization data, a search result storage unit, a cost table storage unit (that convert said item name (information) to cost), a cost calculation unit, and the like. The technical idea of acquiring the procedure information from said standardization data of USPTO and calculating the cost and the like is known, and the following is an example of the processing. Naturally, other various processes may be used as appropriate.

The “standardization data of USPTO acquisition unit” has a function of acquiring standardization data. The standardization data is data processed by organizing and standardizing various information such as examination process information between the applicant and the examiner held by the USPTO. By referring to the standardization data, it is possible to know information such as the filing date, applicant, trademark right holder, and so on, the process of examination, and the like.

The “information extraction unit” has a function of searching for a combination of standard item names (information) indicating a legal procedure taken for a trademark described in the acquired standardization data for example a procedure and a result by a pattern matching process using a prepared pattern, and extracting information described in the standardization data in association with the procedure date according to the searched combination of standard item names (information). The combination of standard item names (information) indicating the legal procedure taken for the trademark is, for example, when a legal procedure of an invalidation trial is taken for a trademark, a combination of standard item names (information) such as the type of a trial, the type of final disposition of a trial, and the conclusion of the trial, and the like. With this combination, the legal procedure of invalidation trial is searched by performing the pattern matching process on the standardization data. In the standardization data, data for searching for the legal procedure of invalidation trial and knowing the result is scattered, so it is necessary to extract information and the like by performing the pattern matching process.

Next, a method of extracting information described in the standardization data according to the combination of the searched standard item names (information) will be described. Information for the standard item name “type of a trial” is “new invalid”, Information for the standard item name “type of final disposition of a trial” is “invalidity of a claim”, Information for “conclusion” of the standard item name “trial” is “not invalidated”.

Then, the date when the procedure was performed is extracted in association with this information. For example, in the case of an invalidation trial, the “date of request for trial” is extracted.

The “search result storage unit” has a function of holding the extracted information and the procedure date associated therewith in association with the combination of the searched standard item names (information). For example, trial type: new invalid, reason: invalidity of a claim, and result: not invalidated are held in association with the combination of standard item names (information) as information, and 2004 Apr. 1 as the procedure date is also held in association with the combination of standard item names (information). By referring to the held search result, it is possible to know the date of the request for an invalidation trial, the type of a trial, the type of final disposition of a trial, and the conclusion of a trial, which are the legal procedure taken for a trademark in USPTO.

The “cost table storage unit (that convert said item name (information) to cost)” has a function of holding a cost table associated with the cost prepared in advance for each combination of information held in association with a combination of standard item names (information). For example, the combinations of the standard item names (information) for an invalidation trial are the type of a trial, the type of final disposition of a trial, the decision of a trial, and the like. There may be a case in which an invalidation trial has occurred, the final disposition has been invalidated, and the trial decision has not been invalidated. In this case, the cost that a third party spent on the invalidation trial, for example, 3,000 (three thousand) dollars, is stored in the cost table as a cost. Another example is a case in which an invalidation trial has occurred, the final disposition has been established, and the decision has been invalidated. In this case, the trademark is invalid, and the trademark is considered to have no value, and zero is stored in the cost table as a cost. The cost described in the cost table may be a monetary unit: $, a value obtained by dividing the cost by an appropriate value, or an index corresponding to the legal procedure.

The “summing unit” has a function of summing all calculated costs for the trademark and using the sum as a basic value. This makes it possible to calculate the basic value A for one trademark.

The “trademark value calculation unit” uses the basic value A of the trademark calculated by the summing unit to set the basic value A raised to the power of “N raised to the (K/M)”(M≥1, K≥1) as the trademark value. The trademark value for each trademark right holder can be calculated by tallying the calculated trademark value for each trademark right holder that is the same or deemed as the same. It is a tallying unit for each trademark right holder. If the trademark right holder is a company, this is the trademark value owned by the company, a brand value, and a brand power. And it is good to further have a scale elimination unit which divides a corporate brand value by a factor which shows the size of a company. A corporate brand value calculation device. Factors indicating the size of a company include capital, stock market capitalization, ordinary profit, an inventory, current assets, total assets, the number of employees, revolving capital, accounts payable, accounts receivable, annual sales, and the like. Thus, it is possible to predict how much the brand power (from which eliminates the scale factor) that makes a company grow will boost the growth of the company. This is a ratio, not an absolute value. For example, a company or a group of companies belonging to the same position could have a sales increase of about 10%, a stock market capitalization of about 5% higher, a profit margin of about 2% higher, and so on, in the next two years.

The “output unit” has a function of outputting a basic value A obtained by the summing unit, the number N of trademarks similar to one trademark, a trademark value, and the like. It is also possible to add further the obtained trademark value for each company holding a trademark and see the relationship of the trademark power in the company and between the companies. As described above, the total value and the trademark value output from the “output unit” may be further added in a meaningful group unit.

All or a part of each unit that is a component of the present embodiment is configured by any of hardware, software, and both hardware and software. For example, when a computer is used as an example of realizing these, there are hardware including CPU, a bus, a memory, an interface, a peripheral device, and the like, and software executable on the hardware. As software, by sequentially executing programs expanded on the memory, the functions of the respective units are realized by processing, storing, outputting, and the like of data on the memory and data input via the interface.

In addition, RAM reads out a program for performing various processes to have CPU execute the program and provides a work area for the program. Also, a plurality of memory addresses is respectively assigned to the RAM and ROM, and a program executed by the CPU can exchange data mutually and perform processing by specifying and accessing the memory address.

First, when the trademark evaluation device is turned on, the CPU develops various programs such as an standardization data of USPTO acquisition program, an information extraction program, a search result storage program, a summing program, an output program, and the like held in a storage device such as the ROM, in a work area of the RAM.

Then, the CPU executes the standardization data of USPTO acquisition program to acquire the standardization data of an evaluation object trademark. The acquired standardization data is held in a main memory data area of the RAM. Next, the CPU executes the information extraction program and reads a pattern file held in the storage area such as the ROM into a main memory data area of the RAM.

In a pattern file, a combination of standard item names (information) indicating a legal procedure taken for a trademark is prepared in advance. Then, the combination of standard item names (information) indicating a legal procedure is searched for by a pattern matching process using the pattern file. Then, information and a procedure date corresponding to the combination of the standard item names (information) are extracted. Next, the CPU executes the search result storage program, associates the extracted information and the procedure date with the combination of the standard item names (information), and holds the extracted information and the procedure date in the main memory data area of the RAM. At this time, the CPU reads a cost table held in the storage area such as the ROM into the main memory data area of the RAM. Then, a cost corresponding to a search result held in the main memory data area is obtained by searching for the cost table. Furthermore, the CPU executes the summing program and sums all trademarks. The calculated total value is held in the main memory data area of the RAM.

Furthermore, the CPU executes the output program and outputs the calculated total value via an input/output interface such as a display. The total value is the basic value A for the trademark. Moreover, the CPU executes a similarity number acquisition program, which the number is the number of trademarks having a similar relationship with one trademark, and acquires the number N of trademarks having a similar relationship with another trademark. Furthermore, the CPU uses the A and N acquired by executing the trademark value evaluation program to calculate a trademark value identified by a trademark ID using the value that is calculated by the basic value A raised to the power of “N raised to the (K/M)” (M≥1, K≥1). Actually, the values of M and K are determined by the number of digits that can be processed by the computer.

Moreover, the calculated total value or the value of the trademark value may be stored in a storage device such as an HDD in association with the application number, the registration number, and the like.

<Process Flow>

First, in step 1, standardization data (data published by the USPTO) is obtained. Next, in step 2, a combination of standard item names (information) indicating a legal procedure is searched for by a pattern matching process using a pattern prepared in advance. Next, in step 3, information is extracted in association with the procedure date according to the combination of standard item names (information) retrieved from the standardization data. Next, in step 4, the extracted information and the procedure date associated therewith are held in association with the combination of the standard item names (information). Next, in step 5, a cost table is searched to acquire the corresponding cost. Next, in step 6, all about the trademark is added up. The sum is the basic value A for the trademark. Furthermore, the number N of trademarks having a similar relationship with another trademark is obtained. By using the acquired A and N, a trademark value identified by a trademark ID using the value that is calculated by the basic value A raised to the power of “N raised to the (K/M)” (M≥1, K≥1).

<Other Example 1>

If a trademark right holder that is the same or deemed to be the same as a trademark right holder has trademarks similar to one trademark, the calculated trademark value can be determined as the value of the trademark group (consists of trademarks and one trade mark), and subsequent processing can be performed. Alternatively, the value of a group of trademarks having a similar relationship may be determined as the value of the group of trademarks by averaging the values of all trademarks having a similar relationship. The average can be selected from any of arithmetic mean, geometric mean, harmonic mean, generalized mean, and weighted mean. When a weighted average is used, the weighting may be configured in order that the weight can be selected according to the industry to which applying goods and applying services belong. Furthermore, the value of the trademark group may be configured as calculating by simply adding all calculated values of each trademark.

<Other Example 2>

The corporate brand evaluation device comprising a population trademark ID acquisition unit that acquires a population trademark ID that is trademark IDs of a plurality of trademarks (pending trademarks and/or registered trademarks) serving as a population; a basic value acquisition unit that acquires a basic value A (A>0), which is a basic value for evaluating the value of one trademark identified by the population trademark ID owned by a same trademark right holder, in association with the trademark ID; a corporate brand value calculating unit that sums the trademark value identified by the trademark ID as the basic value A for each trademark right holder that is the same or deemed to be the same.

<Other Example 3>

The corporate brand value calculation device described in Other Example 2, further comprising a scale elimination unit which divides a corporate brand value calculated by the corporate brand value calculating unit by a factor which shows the size of a company. Factors indicating the size of a company include capital, stock market capitalization, ordinary profit, an inventory, current assets, total assets, the number of employees, revolving capital, accounts payable, accounts receivable, annual sales, and the like.

<Embodiment 1: Effect>

By the trademark evaluation device according to the present embodiment, economic evaluation of a group of trademarks can be performed. Until now, it was considered difficult to make a micro-evaluation of the economic value of a trademark group because of the need for enormous cost (for example, about 3 million yen per case) and time for micro-evaluating the economic value of each trademark. Here, the micro-evaluation is to perform a detailed investigation on one trademark and calculate its economic value.

Furthermore, since the total value per trademark calculated by the trademark evaluation device is calculated by using only objective data without using scoring, it has a characteristic that arbitrariness is completely eliminated.

What is claimed is:

1. A trademark evaluation device comprising:
a population trademark ID acquisition unit that acquires a population trademark ID that is trademark IDs of a plurality of trademarks (pending trademarks and/or registered trademarks) serving as a population;
a similar relation holding unit that holds trademark IDs associated with each other, which identify a trademark composed of a similar mark, wherein the trademarks identified by the population trademark ID owned by a same trademark right holder;
a similarity number acquisition unit that acquires the number N, that is the number of trademark IDs held in association with the trademark ID in the similar relation holding unit;
a basic value acquisition unit that acquires a basic value A (A>0), which is a basic value for evaluating the value of one trademark, in association with the trademark ID;
a trademark value calculation unit that calculates the trademark value identified by the trademark ID using the value that is calculated by the basic value A raised to the power of “N raised to the (K/M)” (M, K≥1).

2. The trademark evaluation device of claim 1 further comprising:
a tallying unit that adds up the value of all trademarks and/or trademark groups owned by a trademark right holder in the population for each trademark right holder, wherein if the trademark which the value calculated has another trademark with a similar relationship, the value A raised to the power of “N raised to the (K/M)” (M, K≥1) is the value of the trademark group including another trademark, and if there is no other trademark with a similar relationship, the value A raised to the power of “N raised to the (K/M)” (M, K≥1) is the value of the trademark alone.

3. The trademark evaluation device of claim 2 further comprising an output unit concerning each trademark right holder, which outputs the total value calculated by the tallying unit in association with a trademark right holder.

4. The trademark evaluation device of any one of claims 1 to 3 comprising the population trademark ID acquisition unit, the population trademark ID acquisition unit comprising the first designated population acquisition unit, wherein the first designated population acquisition unit acquires trademark IDs of a plurality of trademarks to be a population as trademark IDs of a population formed by using at least one of applying goods, applying services, a class of the goods, and a class of the services.

5. The trademark evaluation device of any one of claims 1 to 4 comprising the population trademark ID acquisition unit, the population trademark ID acquisition unit comprising the second designated population acquisition unit, wherein the second designated population acquisition unit acquires trademark IDs of a plurality of trademarks to be a population as trademark IDs of a population formed by either a trademark including a company name or a trademark not including a company name.

6. The trademark evaluation device of any one of claims 1 to 5 calculating by using the basic value A as at least one of, the number of years of the life of the registered trademark, the cost for obtaining to register the trademark, the cost for maintaining the registered trademark, the number of classes of goods and services, the number of the established licenses, the number of countries for international applications.
